(19) United States
(12) Patent Application Publication
(10) Pub. No.: US 2026/0043457 A1
(43) Pub. Date: Feb. 12, 2026

(54) Chain Marker

(71) Applicant: Quinton Watts, Bournemouth (GB)

(72) Inventor: Quinton Watts, Bournemouth (GB)

(21) Appl. No.: 19/259,743

(22) Filed: Jul. 3, 2025

Related U.S. Application Data
(63) Continuation-in-part of application No. PCT/EP2023/088030, filed on Dec. 30, 2023.

(30) Foreign Application Priority Data
Jan. 3, 2023 (GB) 2300010.2

(51) Int. Cl. F16G 15/00; F16G 13/12

(52) U.S. Cl. CPC F16G 15/00; F16G 13/12

(57) ABSTRACT

A chain marker comprising: a first body portion having an aperture, a first end and a second opposing end, wherein each of the first and second ends has a recess for receiving at least a portion of a first link of a chain; a second body portion having an aperture and first and second ends, wherein each of the first and second ends has a recess for receiving at least a portion of the first link, wherein the chain marker is adapted such that, in use, the first and second body portions may be brought together such that the apertures of the first and second body portions are aligned for receiving a fastener and the recesses of the first and second ends are aligned such that the first and second body portions encompass at least a portion of the circumference of a straight portion of the first link such that the chain marker is held in position within the aperture of the first link.

The present invention relates to markers which can be attached to tension members such as chains, ropes and the like. In particular, but not exclusively, the present invention relates to chain markers.

Chains, comprising a series of connected links are used in many applications as tension members. One such application is for deploying an anchor of a boat or ship. Each link of the chain is typically stadium shaped having two semi-circular portions and two interposing straight portions. The semi-circular portions and interposing straight portions collectively define an aperture.

It is often desirable to know what length of chain has been deployed. Chain markers are commercially available and these are typically made from a rubber material which can be push fit into the aperture of a particular link which is at the distance to be indicated. For example, a chain marker may be connected to each link which is 1m apart along its length. However, known chain markers are frequently pushed out by the adjacent links when the chain is being deployed or retrieved.

It is desirable to provide an improved chain marker which is more likely to remain in place during use and for a longer period of time.

According to a first aspect of the present invention there is provided a chain marker comprising:
a first body portion having an aperture, a first end and a second opposing end, wherein each of the first and second ends has a recess for receiving at least a portion of a first link of a chain;
a second body portion having an aperture and first and second ends, wherein each of the first and second ends has a recess for receiving at least a portion of the first link,
wherein the chain marker is adapted such that, in use, the first and second body portions may be brought together such that the apertures of the first and second body portions are aligned for receiving a fastener and the recesses of the first and second ends are aligned such that the first and second body portions encompass at least a portion of the circumference of a straight portion of the first link such that the chain marker is held in position within the aperture of the first link.

According to a further aspect there is provided a chain marker comprising:
a first body part having an aperture, a first end and a second opposing end, wherein each of the first and second ends has a recess for receiving a link of a chain;
a second body part having an aperture and first and second ends, wherein each of the first and second ends has a recess for receiving at least a portion of the first link,
wherein the chain marker is adapted such that, in use, the first and second body portions may be brought together such that the apertures of the first and second body portions are aligned for receiving a fastener and the recesses of the first and second ends are aligned such that the first and second body portions encompass a portion of the link such that the chain marker is held in position within the aperture of the link.

Optionally, each of the first and second ends of the first body portion has a recess for receiving at least a portion of a straight portion of the first link.

Optionally, each of the first and second ends of the second body portion has a recess for receiving at least a portion of a straight portion of the first link.

Optionally, each of the first and second ends is concave to form the recess. Optionally, each of the first and second ends is concave in a manner corresponding to the outer circumference of the first link.

Optionally, the first and second ends encompass an arc of the circumference of a straight portion when the first and second body portions are brought together.

Optionally, the first and second ends encompass less than or equal to a 90 degree arc of the circumference of a straight portion when the first and second body portions are brought together.

Optionally, each of the first and second body portions include a third end and a fourth opposing end. Optionally, each of the third and fourth ends has a recess for receiving a portion of a semi-circular portion of an adjacent link of a chain which is present in the aperture of the first link.

Optionally, each of the third and fourth ends is concave to form the recess. Optionally, each of the third and fourth ends is concave in a manner corresponding to the outer circumference of the adjacent link.

Optionally, one of the first and second body portions includes a protrusion provided around the aperture.

Optionally, the other of the first and second body portions includes a cavity provided around the aperture.

Optionally, the chain marker is adapted such that, when the first and second body portions are brought together, the protrusion mates with the cavity.

Optionally, each of the first and second body portions are formed from a rigid material.

Optionally, the apertures of the first and second body portions are adapted to receive a fixing such as a screw fastener.

Optionally, at least one of the apertures of the first and second body portions may be internally threaded.

Alternatively, the apertures of the first and second body portions are adapted to receive a screw or bolt fastener.

Optionally, the chain marker is adapted such that it is positionable substantially within a volume defined by the aperture of a link.

Alternatively, one or both of the first and second body portions may include wing members which extend beyond the volume defined by the aperture of a link. Optionally, each of the first and second body portions may include wing members. Optionally, the wing members may be provided at the first and second ends.

Optionally, the first and second body portions are separate units before being brought together.

Optionally, the chain marker may include a tether which connects the first and second body portions. The joining of the two halves may be used for convenience and may not be integral to the function of the chain marker. If the marker was manufactured in metal, for example, this might not be the case.

In some embodiments there is provided a chain marker for insetting and locking inside the chain hole of a series of a chain links. The marker comprises two parts (male, female) interconnected by a fastening lug and a fastening lug cavity and held together with a fixing such as a screw or bolt. The marker may have a body which is made of a (hard) plastics material or a metal and can, for example, be finished in varying colours. The direction of the connection may be with the male and female parts coming together from either side of the chain hole. With the fastening lug located into the fastening lug cavity a fastening screw or bolt can be inserted through a fastener hole and located into a fastener receiver.

Some embodiments comprise one or more of the following features:
Made of a rigid (non-compliant) material such as a plastics material.
Made of two halves which locate into each other from either side of the chain link.
One half has an indentation into which a protrusion from the second half locates.
The two halves are mechanically held together with fastener/fixing such as a screw or bolt for larger chain markers.
The markers can be made of many different colours to denote specific locations on a chain.

In some embodiments an important part of the design is the protrusion from the one half to locate into the second half. Without this there is a lot less material for the fastener to bite into and the two halves may not stay together as well.

Further aspects and embodiments are listed in the following numbered paragraphs.
1. A chain marker comprising:
   a first body portion having an aperture, a first end and a second opposing end, wherein each of the first and second ends has a recess for receiving at least a portion of a first link of a chain;
   a second body portion having an aperture and first and second ends, wherein each of the first and second ends has a recess for receiving at least a portion of the first link,
   wherein the chain marker is adapted such that, in use, the first and second body portions may be brought together such that the apertures of the first and second body portions are aligned for receiving a fastener and the recesses of the first and second ends are aligned such that the first and second body portions encompass at least a portion of the circumference of a straight portion of the first link such that the chain marker is held in position within the aperture of the first link.
2. A chain marker according to paragraph 1, wherein each of the first and second ends of the first body portion has a recess for receiving at least a portion of a straight portion of the first link.
3. A chain marker according to paragraph 1 or 2, wherein each of the first and second ends of the second body portion has a recess for receiving at least a portion of a straight portion of the first link.
4. A chain marker according to paragraph 2 or 3, wherein each of the first and second ends is concave to form the recess.
5. A chain marker according to paragraph 4, wherein each of the first and second ends is concave in a manner corresponding to the outer circumference of the first link.
6. A chain marker according to paragraph 4 or 5, wherein the first and second ends encompass an arc of the circumference of a straight portion when the first and second body portions are brought together.
7. A chain marker according to paragraph 6, wherein the first and second ends encompass less than or equal to a 90 degree arc of the circumference of a straight portion when the first and second body portions are brought together.
8. A chain marker according to any preceding paragraph, wherein each of the first and second body portions include a third end and a fourth opposing end.
9. A chain marker according to paragraph 8, wherein each of the third and fourth ends has a recess for receiving a portion of a semi-circular portion of an adjacent link of a chain which is present in the aperture of the first link.
10. A chain marker according to paragraph 9, wherein each of the third and fourth ends is concave to form the recess.
11. A chain marker according to paragraph 10, wherein each of the third and fourth ends is concave in a manner corresponding to the outer circumference of the adjacent link.
12. A chain marker according to any preceding paragraph, wherein one of the first and second body portions includes a protrusion provided around the aperture.
13. A chain marker according to paragraph 12, wherein the other of the first and second body portions includes a cavity provided around the aperture.
14. A chain marker according to paragraph 13, wherein the chain marker is adapted such that, when the first and second body portions are brought together, the protrusion mates with the cavity.
15. A chain marker according to any preceding paragraph, wherein each of the first and second body portions are formed from a rigid material.
16. A chain marker according to any preceding paragraph, wherein the apertures of the first and second body portions are adapted to receive a fastener.
17. A chain marker according to any preceding paragraph, wherein the chain marker is adapted such that it is positionable within a volume defined by the aperture of a link.
18. A chain marker according to any of paragraphs 1 to 16, wherein, one or both of the first and second body portions includes wing members which extend beyond the volume defined by the aperture of a link.
19. A chain marker according to paragraph 18, wherein each of the first and second body portions includes wing members.
20. A chain marker according to paragraph 19, wherein the wing members are provided at the first and second ends.
21. A chain marker according to any preceding paragraph, wherein the first and second body portions are separate units before being brought together.
22. A chain marker according to any preceding paragraph, wherein the chain marker includes a tether which connects the first and second body portions.
23. A chain marker for insetting and locking inside the chain hole of a series of a chain links, the marker comprises two parts which are interconnectable together.
24. A marker according to paragraph 24, in which the direction of connection is with male and female parts coming together from either side of a chain hole.
25. A marker according to paragraph 23 or paragraph 24, in which a fastening lug locates into a fastening lug cavity and a fastener can be inserted through a fastener hole and located into a fastener receiver.
26. A chain marker for insetting and locking inside the chain hole of a series of a chain links, the marker comprises two parts interconnectable together.
27. A chain marker according to paragraph 26, comprising a male part and a female part and configured to connect with the male and female parts coming together from either side of a chain hole.
28. A chain marker according to paragraph 26 or claim 27, comprising a fastening lug and a fastening lug cavity held together with a fixing such as a screw or bolt.
29. A set of chain markers comprising a plurality of chain markers according to any preceding paragraph.
30. A chain having one or more markers or sets according to any preceding paragraph.
31. A chain marker comprising:
   a first body portion having an aperture, a first end and a second opposing end, wherein each of the first and second ends has a recess for receiving at least a portion of a first link of a chain;
   a second body portion having an aperture and first and second ends, wherein each of the first and second ends has a recess for receiving at least a portion of the first link,
   wherein the chain marker is adapted such that, in use, the first and second body portions may be brought together such that the apertures of the first and second body portions are aligned for receiving a fastener and the recesses of the first and second ends are aligned such that the first and second body portions encompass at least a portion of the circumference of a straight portion of the first link such that the chain marker is held in position within the aperture of the first link,
   in which one of the first and second body portions has a toothed recess and the other portion has a corresponding shaped protrusion whereby when fitted together rotational movement between the portions is prevented.
32. A chain marker comprising:
   a first body part having an aperture, a first side and a second opposing side, wherein each of the first and second sides has a recess for receiving a link of a chain;
   a second body part having an aperture and first and second sides, wherein each of the first and second sides has a recess for receiving at least a portion of the first link,
      wherein the chain marker is adapted such that, in use, the first and second body portions may be brought together such that the apertures of the first and second body portions are aligned for receiving a fastener and the recesses of the first and second sides are aligned such that the first and second body portions encompass a portion of the link such that the chain marker is held in position within the aperture of the link,
   in which one of the first and second body parts has a toothed recess and the other part has a corresponding shaped protrusion whereby when fitted together rotational movement between the parts is prevented.

Some embodiments comprise a marine-grade screw and a tough water-resistant polymer body.

The present invention also provides a set of chain markers comprising a plurality of chain markers as described herein.

The present invention also provides a chain having one or more markers or sets as described herein.

Different aspects and embodiments of the invention may be used separately or together.

The present invention will now be more particularly described, by way of example only, with reference to the accompanying drawings, in which:

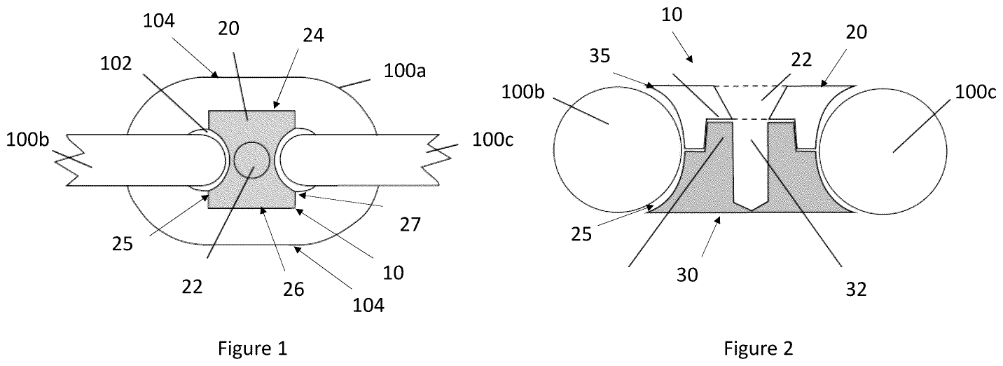

FIG. 1 is a top view of a chain marker according to a first embodiment of the present invention fitted to a first link of a chain;

FIG. 2 is a cross sectional side view of the chain marker of FIG. 1 fitted to the first link;

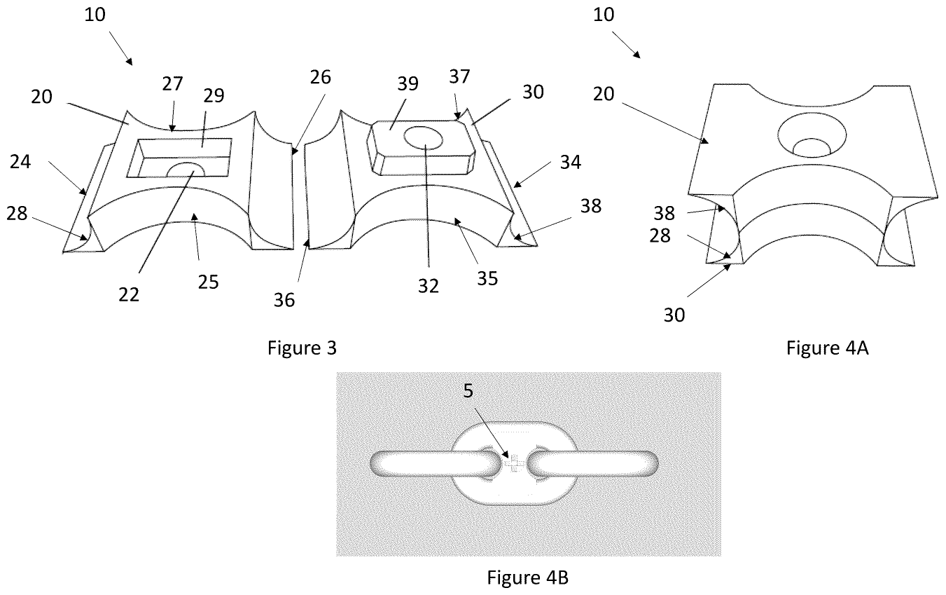

FIG. 3 is a perspective view of the chain marker of FIG. 1 in a disassembled state;

FIGS. 4A-4B are perspective views of the chain marker of FIG. 1 in an assembled (FIG. 4A) and inserted (FIG. 4B) state;

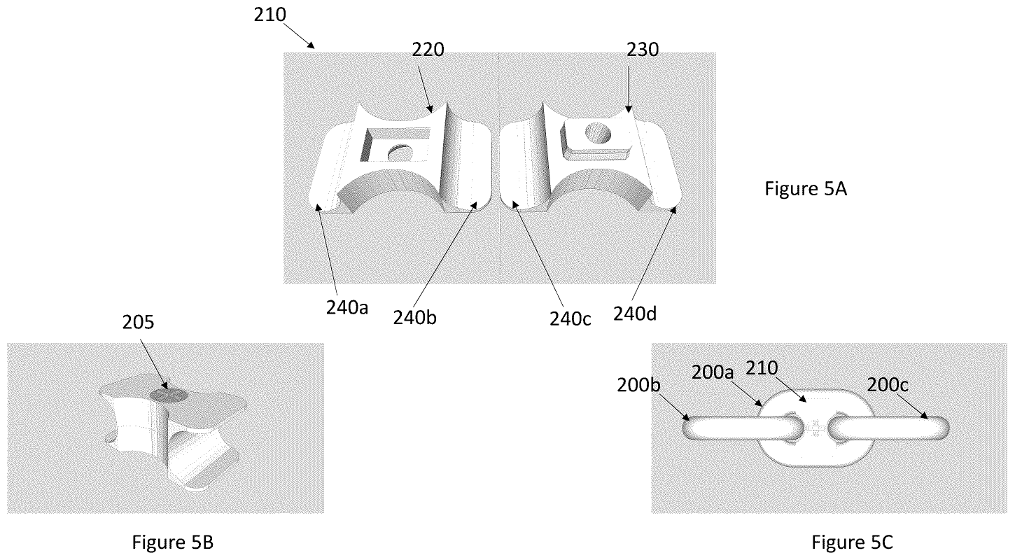

FIGS. 5A-5C are perspective views of a chain marker according to a further embodiment of the present invention in disassembled (FIG. 5A), assembled (FIG. 5B) and inserted (FIG. 5C) states;

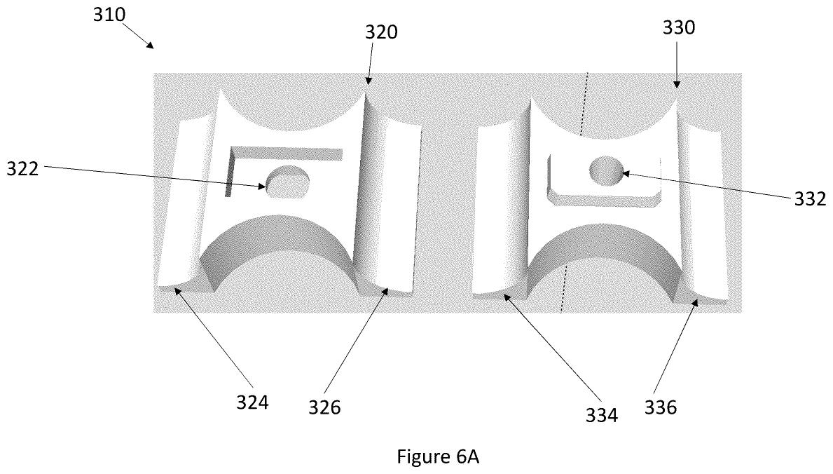

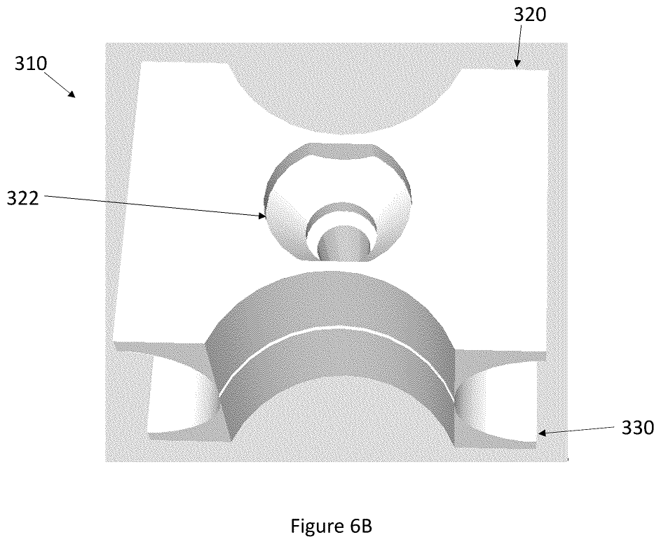

FIG. 6A shows chain marker parts formed according to a further embodiment;

FIG. 6B shows the parts of FIG. 6B fitted together;

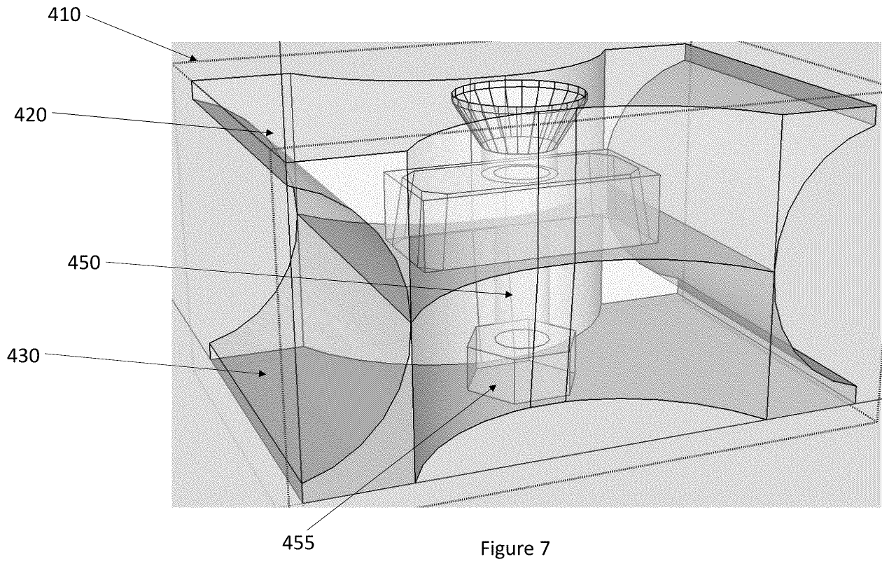

FIG. 7 shows a chain marker formed according to a further embodiment;

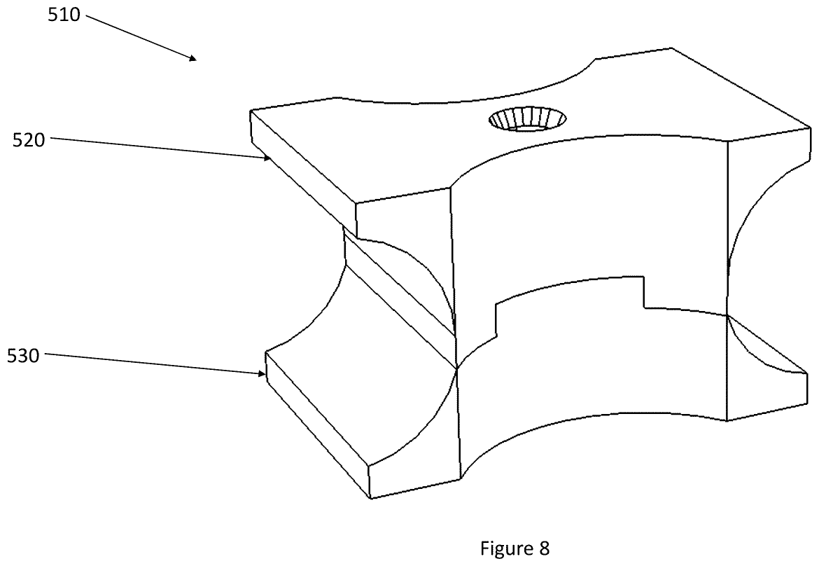

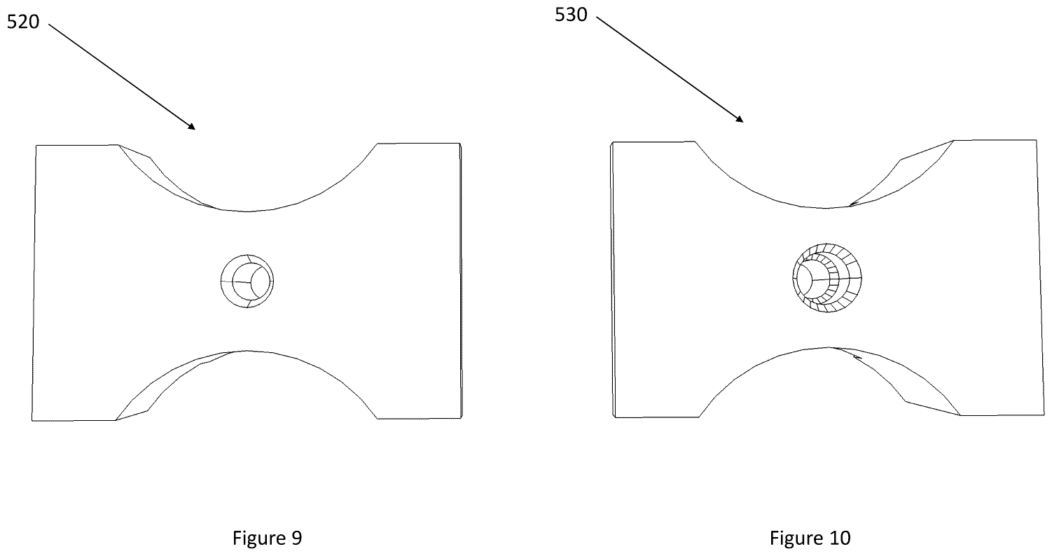

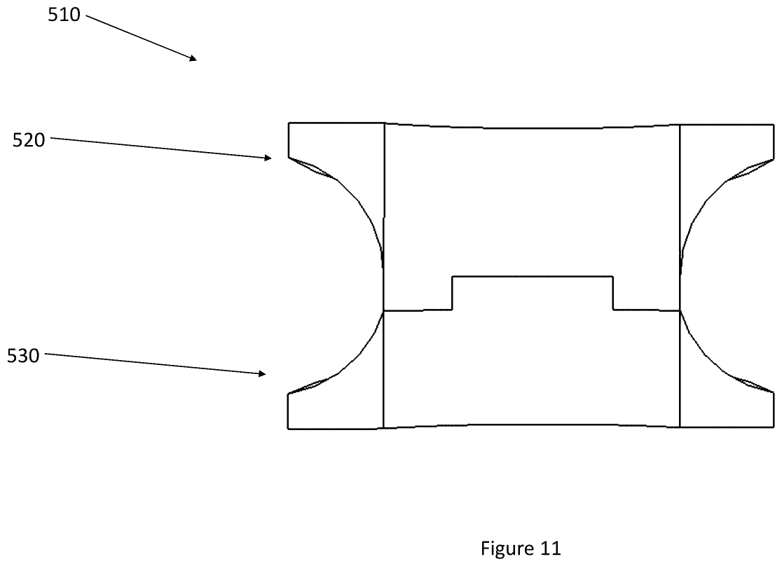

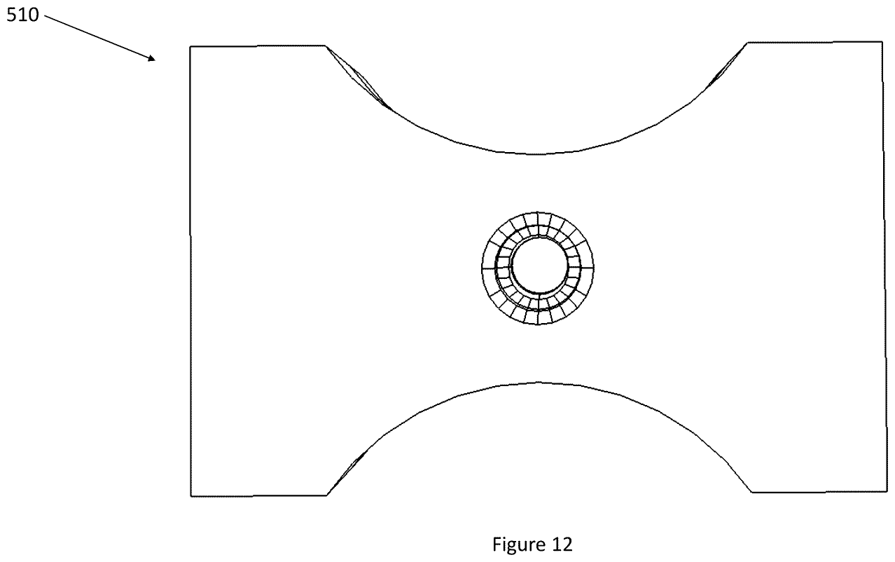

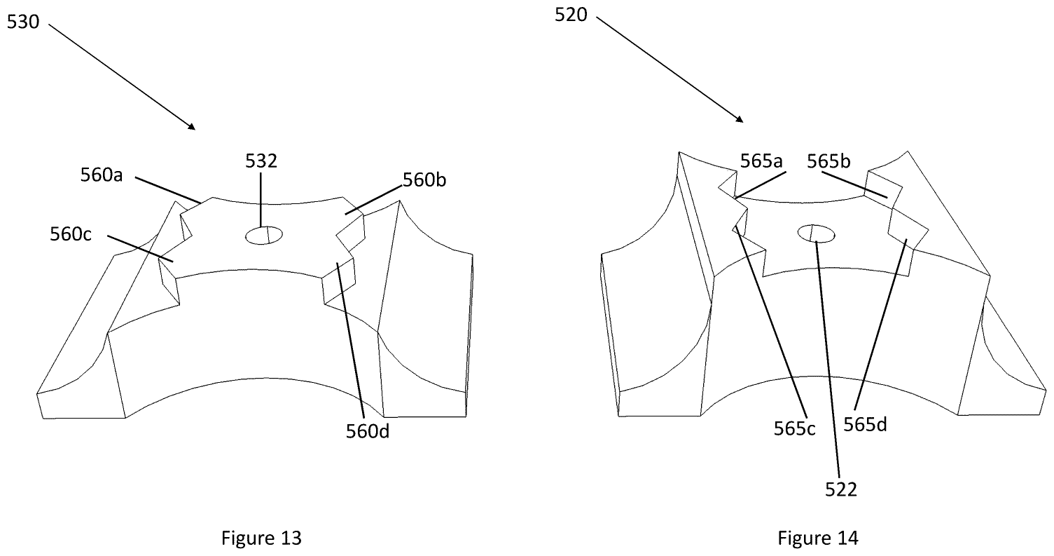

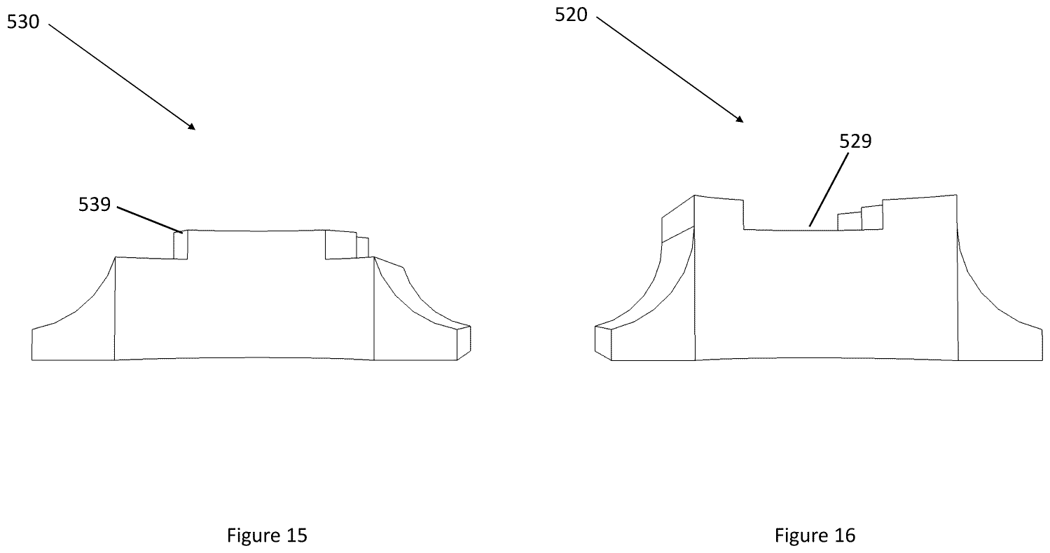

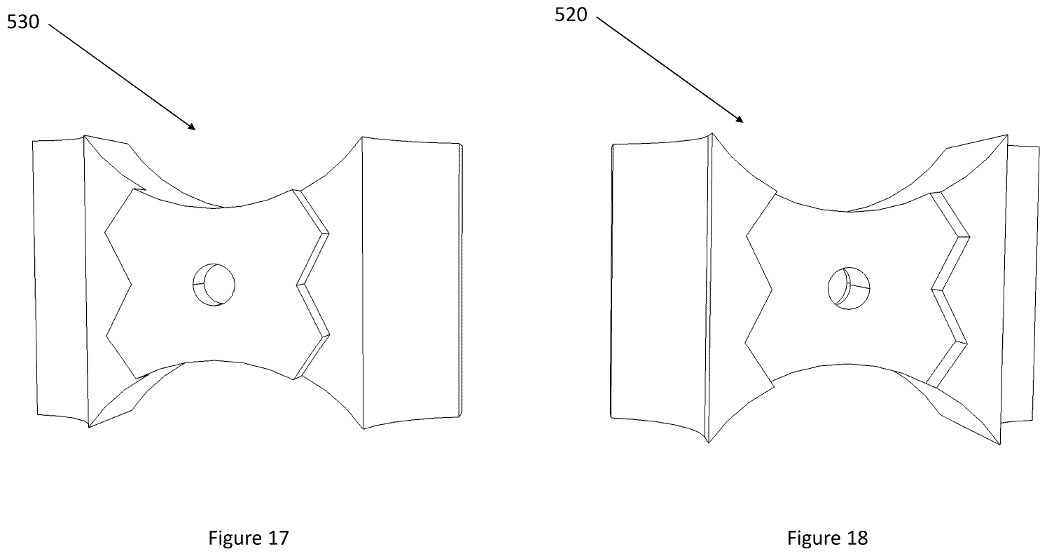

FIGS. 8 to 18 show views of a chain marker formed according to a further embodiment; and

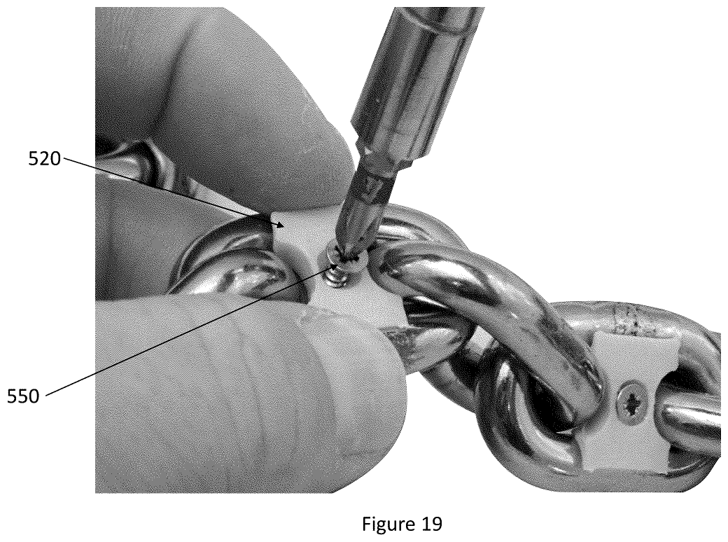

FIG. 19 shows a chain marked formed in accordance with the present invention and being fitted to a chain

Example embodiments are described below in sufficient detail to enable those of ordinary skill in the art to embody and implement the systems and processes herein described. It is important to understand that embodiments can be provided in many alternate forms and should not be construed as limited to the examples set forth herein.

Accordingly, while embodiments can be modified in various ways and take on various alternative forms, specific embodiments thereof are shown in the drawings and described in detail below as examples. There is no intent to limit to the particular forms disclosed. On the contrary, all modifications, equivalents, and alternatives falling within the scope of the appended claims should be included. Elements of the example embodiments are consistently denoted by the same reference numerals throughout the drawings and detailed description where appropriate.

The terminology used herein to describe embodiments is not intended to limit the scope. The articles “a,” “an,” and “the” are singular in that they have a single referent, however the use of the singular form in the present document should not preclude the presence of more than one referent. In other words, elements referred to in the singular can number one or more, unless the context clearly indicates otherwise. It will be further understood that the terms “comprises,” “comprising,” “includes,” and/or “including,” when used herein, specify the presence of stated features, items, steps, operations, elements, and/or components, but do not preclude the presence or addition of one or more other features, items, steps, operations, elements, components, and/or groups thereof.

Unless otherwise defined, all terms (including technical and scientific terms) used herein are to be interpreted as is customary in the art. It will be further understood that terms in common usage should also be interpreted as is customary in the relevant art and not in an idealized or overly formal sense unless expressly so defined herein.

Referring first to FIG. 1, there is shown a chain marker 10 fitted within the aperture 102 of a first link 100 a of a chain. The chain marker 10 comprises a first body portion 20 and a second body portion 30. Each of the first and second body portions has an aperture 22, 32 for receiving a fastener (not shown).

The first and second body portions can be brought together. For example, in FIG. 3, the first body portion 20 can be rotated 180 degrees and positioned on top of the second body portion 30 as shown in FIGS. 4A-4B. The two portions will mate, as is described below, and, when mated, the apertures 22, 32 of the first and second body portions will be aligned. A fastener can be applied to the apertures 22, 32 to connect the first and second body portions together. If this is done with the chain marker 10 positioned within the aperture 102 of the first link 100 a and the chain interposing the first and second body portions (as shown in FIGS. 1 and 2), the chain marker 10 will be attached to the chain in a secure manner.

Typically, chains are supplied in standard sizes. The chain marker 10 is configured for a particular size of chain (and other versions can be provided for other sizes).

Each of the first and second body portions also has a first end 24, 34 and a second opposing end 26, 36. Each of the first and second ends has a recess 28, 38 for receiving a portion of the first link 100a. In the embodiment shown, the first and second ends are concaved to form the recess. Specifically, the first end 24, 34 of each of the first and second body portions is concaved in one plane such that the end surface of each of the first and second body portions defines an arc of a circle with a radius equal to that of the first link 100a. This arc is less than 90 degrees for each of the first and second body portions such that, when the first and second body portions are brought together, the total arc is approximately 180 degrees.

If the first and second body portions are brought together (and the fastener applied) when positioned on either side, and within the aperture 102, of the first link 100a, a portion of the straight portion 104 of the first link 100 a will be received in each of the two total recesses formed by the first and second body portions in a close fit manner. Therefore, the chain marker 10 will be fixed relative to the first link 100a in one lateral direction (up and down in FIG. 1).

Also, the outer surfaces of the first and second body portions will extend beyond the minimum distance between the two straight portions of the first link 100 a. Therefore, the chain marker 10 will be fixed relative to the first link 100a in a second, orthogonal, lateral direction (up and down in FIG. 2).

Each of the first and second body portions also includes a third end 25, 35 and a fourth opposing end 27, 37. Each of the third and fourth ends has a recess for receiving a portion of a semi-circular portion of an adjacent link 100b, 100c of a chain which is present in the aperture 102 of the first link 100a.

Each of the third and fourth ends is concave to form the recess. The third and fourth ends are concave within a second plane which is orthogonal to the first plane. The end surface of each of the third and fourth ends defines an arc of a circle with a radius equal to that of the first link 100a. This arc is less than or equal to 180 degrees.

When the first and second body portions are brought together, a portion of the semi-circular portion of an adjacent link 100b will be received in each recess of the third and fourth ends in a close fit manner. Therefore, the chain marker 10 will be fixed relative to the first link 100a in a third, orthogonal, lateral direction (left and right in FIG. 1).

The fastener 5 (see FIG. 4B) can be a screw or a bolt. A screw is preferred so that no portion of the fastener extends beyond the volume of the chain marker 10. The aperture of the second body portion 30 may be internally threaded. It is also closed at the bottom (shown in FIG. 2). In other embodiments, the aperture can be open such as to allow a bolt to pass through for a nut to be applied.

The second body portion 30 includes a protrusion 39 provided around the aperture 32. This provides more material for the fastener to catch. Also, the first body portion 20 includes a cavity 29 provided around the aperture 22. When the first and second body portions are brought together, the protrusion 39 mates with the cavity 29. This assists in correctly aligning the apertures.

The first and second body portions are formed from a rigid material such as metal or a tough plastic. Thus, the first and second body portions will resist deformation unlike the resilient materials used for conventional chain markers.

Due to the geometry of the chain marker 10, it is positionable within a volume defined by the aperture 102 of a link. This means it is less likely to catch on any equipment such as rollers and winches during deploying or retrieval. However, in other embodiments, the chain marker 10 may be configured to extend beyond this volume. For instance, this may be done to improve visibility of the chain marker 10.

FIGS. 5A-5C show a second embodiment of the invention.

The chain marker 210 is similar to the first embodiment except that wing members 240 are provided which extend beyond the volume defined by the aperture of a link. Each of the first and second body portions includes wing members 240a-d provided at each of the first and second ends. The wings can be used to increase visibility of the marker within the chain link.

FIGS. 6A and 6B show a chain marker 310 formed according to a further embodiment. In this embodiment (compared to the embodiment of FIGS. 5A to 5C) the opposing ends of the chain markers have been shortened; there are no wings.

FIG. 7 shows a marker 410 formed according to a further embodiment.

In this embodiment the assembled first and second body portions 420, 430 are held together by a bolt 450 going all the way through, secured (for example) with a nut 455 or metal insert.

In the embodiments shown, the first and second body portions are separate units before being brought together. In other embodiments (not shown), the chain marker 10 can includes a tether which connects the first and second body portions. This helps to keep the two parts together and avoid the loss of one of them when initially supplied. The tether may be sacrificial: it may be removable prior to use of the chain marker 10. This avoids the possibility of the tether catching on equipment.

FIGS. 8 to 18 show a chain maker 510 formed according to a further embodiment.

The chain marker comprises a first body part 520 which has an aperture, a first side and a second opposing side. Each of the first and second sides has a recess for receiving a link of a chain.

The chain marker comprises a second body 530 part having an aperture and first and second sides. Each of the first and second sides has a recess for receiving at least a portion of the first link.

The chain marker is adapted such that, in use, the first and second body portions may be brought together such that the apertures of the first and second body portions are aligned for receiving a fastener and the recesses of the first and second sides are aligned such that the first and second body portions encompass a portion of the link such that the chain marker is held in position within the aperture of the link.

The second body part 530 includes a protrusion 539 provided around the aperture 532.

The first body part 520 includes a cavity/recess 529 provided around the aperture 522.

When the first and second body portions are brought together, the protrusion 539 mates with the cavity 529. This assists in correctly aligning the apertures.

The protrusion 539 is a toothed protrusion and the recess 529 is a corresponding shaped toothed recess, whereby when fitted together rotational movement between the parts is prevented.

The toothed recess 529 comprises four tooth recess 560a-d arranged in two pairs of opposing recess.

The toothed protrusion comprises four teeth 565a-d arranged in two pairs of opposing teeth.

The aperture 522 in the body part 520 is formed generally at the centre of the recess, and at the centre of the part.

The aperture 532 in the body part 530 is formed generally at the centre of the protrusion, and at the centre of the part.

The apertures in the body parts receive a fixing/fastener 550, as illustrated by way of example in FIG. 19, to secure the marker in a chain link.

Although illustrative embodiments of the invention have been disclosed in detail herein, with reference to the accompanying drawings, it is understood that the invention is not limited to the precise embodiments shown and that various changes and modifications can be effected therein by one skilled in the art without departing from the scope of the invention as defined by the appended claims and their equivalents.

1. A chain marker comprising:
a first body portion having an aperture, a first end and a second opposing end, wherein each of the first and second ends has a recess for receiving at least a portion of a first link of a chain;
a second body portion having an aperture and first and second ends, wherein each of the first and second ends has a recess for receiving at least a portion of the first link,
wherein the chain marker is adapted such that, in use, the first and second body portions may be brought together such that the apertures of the first and second body portions are aligned for receiving a fastener and the recesses of the first and second ends are aligned such that the first and second body portions encompass at least a portion of the circumference of a straight portion of the first link such that the chain marker is held in position within the aperture of the first link.

2. A chain marker as claimed in claim 1, wherein each of the first and second ends of the first body portion has a recess for receiving at least a portion of a straight portion of the first link.

3. A chain marker as claimed in claim 1, wherein each of the first and second body portions include a third end and a fourth opposing end.

4. A chain marker as claimed in claim 1, wherein one of the first and second body portions includes a protrusion provided around the aperture and wherein the other of the first and second body portions includes a cavity provided around the aperture.

5. A chain marker as claimed in claim 4, wherein the chain marker is adapted such that, when the first and second body portions are brought together, the protrusion mates with the cavity.

6. A chain marker as claimed in claim 1, wherein the apertures of the first and second body portions are adapted to receive a fastener.

7. A chain marker as claimed in claim 1, wherein the chain marker is adapted such that it is positionable within a volume defined by the aperture of a link.

8. A chain marker as claimed in claim 1, wherein, one or both of the first and second body portions includes wing members which extend beyond the volume defined by the aperture of a link.

9. A chain marker as claimed in claim 1, wherein the first and second body portions are separate units before being brought together.

10. A chain marker as claimed in claim 1, wherein the chain marker includes a tether which connects the first and second body portions.

11. A chain marker for insetting and locking inside the chain hole of a series of a chain links, the marker comprises two parts interconnectable together.

12. A chain marker as claimed in claim 11, comprising a male part and a female part and configured to connect with the male and female parts coming together from either side of a chain hole.

13. A chain marker as claimed in claim 11, comprising a fastening lug and a fastening lug cavity held together with a fixing such as a screw or bolt.

14. A chain marker comprising:
a first body part having an aperture, a first side and a second opposing side, wherein each of the first and second sides has a recess for receiving a link of a chain;
a second body part having an aperture and first and second sides, wherein each of the first and second sides has a recess for receiving at least a portion of the first link,
wherein the chain marker is adapted such that, in use, the first and second body portions may be brought together such that the apertures of the first and second body portions are aligned for receiving a fastener and the recesses of the first and second sides are aligned such that the first and second body portions encompass a portion of the link such that the chain marker is held in position within the aperture of the link,
in which one of the first and second body parts has a toothed recess and the other part has a corresponding shaped protrusion whereby when fitted together rotational movement between the parts is prevented.
